(19) United States
(12) Patent Application Publication
(10) Pub. No.: US 2002/0046893 A1
(43) Pub. Date: Apr. 25, 2002

(54) Two/four-wheel drive switching device for vehicle

(76) Inventors: Akio Handa, Saitama (JP); Noriaki Takano, Saitama (JP)

Correspondence Address: BIRCH STEWART KOLASCH & BIRCH, PO BOX 747, FALLS CHURCH, VA, 22040-0747, US

(21) Appl. No.: 09/964,426

(22) Filed: Sep. 28, 2001

(30) Foreign Application Priority Data
Sep. 29, 2000 (JP) 2000-300396

(51) Int. Cl. B60K 17/344; B60K 23/08

(52) U.S. Cl. 180/247; 180/233

(57) ABSTRACT

A two/four-wheel drive switching device for a vehicle which permits a rear brake an engine brake to be applied to front and rear wheels even in a two-wheel drive mode and which can minimize a switching noise. A switching unit permits and inhibits the transfer of power in a power transfer mechanism and is provided with a drive shaft. A driven shaft is fitted on the drive shaft through an annular clearance. An odd number of engaging/disengaging members are disposed in the clearance between the drive shaft and the driven shaft to connect and disconnect both shafts. A switching mechanism is provided for locating the engaging/disengaging members selectively in a position in which the drive shaft and the driven shaft are connected together and a position in which both shafts are disconnected from each other. An elastic member urges the engaging/disengaging members in a direction to connect the drive shaft and the driven shaft with each other, wherein in a two-wheel drive mode the engaging/disengaging members are moved in a direction to disconnect the drive shaft and the driven shaft from each other against an elastic force of the elastic member.

### CROSS-REFERENCE TO RELATED APPLICATIONS

The present application claims priority under 35 USC 119 to Japanese Patent Application No. 2000-300396 filed on Sep. 29, 2000, the entire contents thereof are hereby incorporated by reference.

### BACKGROUND OF THE INVENTION

1. Field of the Invention

The present invention relates to a two/four-wheel drive switching device for a vehicle.

2. Description of Background Art

Heretofore there has been known a vehicle capable of traveling while switching two- and four-wheel drives from one to the other. FIGS. 4 and 5 show an example of such a vehicle.

In FIGS. 4 and 5, a vehicle 1 is roughly constituted of a body frame 3 with an engine 2 mounted centrally thereon, front wheels 4 and rear wheels 5 are disposed on both sides of front and rear portions, respectively, of the body frame 3. A steering handle 6 is attached to a front upper portion of the body frame 3 to steer the front wheels 4. A fuel tank 7 is installed on the body frame 3 at a position above the engine 2. A seat 8 is installed behind the fuel tank 7.

As shown in FIG. 5, the front wheels 4 are supported vertically movably by suspension units 9 respectively which are provided on both sides of the front portion of the body frame 3. The rear wheels 5 are supported vertically movably by suspension units 10 which are provided on both sides of the rear portion of the body frame 3.

A final reduction unit 13 for front wheels and a final reduction unit 14 for rear wheels are provided centrally in the front and rear portions of the body frame 3. The final reduction units 13 and 14 are connected to the engine 2 through propeller shafts 11 and 12, respectively. Right and left front wheels 4 and right and left rear wheels 5 are connected to the final reduction units 13 and 14, respectively.

For example, between the final reduction unit 13 for the front wheels and the propeller shaft 11 is disposed a two/four-wheel drive switching device which permits or inhibits the transfer of power to the front wheels 4 for switching to a rear wheel drive or a four-wheel drive.

Alternatively, the aforesaid two/four-wheel drive switching device is disposed between the rear propeller shaft 12 and the final reduction unit 14 for the rear wheels for switching to a front-wheel drive or a four-wheel drive.

Such drive mode switching is performed by a vehicle driver in accordance with a road surface condition and a traveling condition.

With regard to the two/four-wheel drive switching device, there has been proposed a switching device of such a structure as shown in FIG. 6 for example.

In FIG. 6, the two/four-wheel drive switching device 15, is formed by dividing an input shaft 16 which is positioned on the final reduction unit 13 side for the front wheels axially into two. The drive switching device 15 includes two input shaft components 16a and 16b confronting and aligned with each other and a switching unit 17 for connecting and disconnecting the input shaft components.

To be more specific, a cylindrical, positioning protrusion 18 is formed centrally on an end face of the input shaft component 16a which is positioned on the final reduction unit 13 side for the front wheels. A positioning recess 19 is formed centrally in an end face of the input shaft component 16b which is positioned outside. The positioning protrusion 18 is rotatably fitted in the recess 19. By confronting both input shaft components 16a and 16b with each other so that the positioning protrusion 18 and the positioning recess 19 are fitted together, both input shaft components 16a and 16b are aligned with each other and are connected together so as to permit a relative rotation.

Outer peripheral surfaces of the confronting portions of the input shaft components 16a and 16b are splined (not shown) and the switching unit 17 is provided in a surrounding relation to the said confronting portions.

An inner surface of the switching unit 17 is splined and is slidably fitted on the confronting portions of the input shaft components 16a and 16b. The switching unit 17 is made up of a switching ring 20 that is adapted to be engaged with and disengaged from the splines of both input shaft components and a drive mechanism 21 including a solenoid. The drive mechanism 21 causes the switching ring 20 to slide axially of both input shaft components 16a and 16b selectively up to a position in which the switching ring 20 comes into engagement with only one input shaft component 16a and a position in which the switching ring comes into engagement with the splines of both input shaft components 16a and 16b simultaneously.

In the two/four-wheel drive switching device 15 thus constructed, with the drive mechanism 21, the switching ring 20 is moved in one direction into engagement with only one input shaft component 16a, cutting off the transfer of driving power to the front wheels 4 and thereby switching into a two-wheel drive mode in which only the rear wheels are driven. Further, by allowing the switching ring 20 to slide into engagement with the other input shaft component 16b in its engaged state with one input shaft component 16a, to couple both input shaft components 16a and 16b and transferring the driving force to the front wheels 4, i.e., it is possible to switch to a four-wheel drive mode in which the front wheels 4 and the rear wheels 5 are driven simultaneously.

In such a conventional two/four-wheel drive switching device 15 the following problems remain to be solved.

If a braking operation is conducted with the rear brake in the two-wheel drive mode, for example the rear wheels 5 are braked, while the front wheels 4 are not braked, so that there occurs a difference between a braking sense in the two-wheel drive mode as compared to the four-wheel drive mode.

The same problem occurs also when an engine brake is applied.

For solving such a problem, it is necessary to make a brake setting which is valid in both the two-wheel drive mode and four-wheel drive mode. This can be coped with using a complicated control mechanism, but an increase in cost will result.

Further, a noise may occur at the time of coupling both input shaft components 16a and 16b.

### SUMMARY AND OBJECTS OF THE INVENTION

The present invention has been accomplished in view of such conventional problems and it is an object of the invention to provide a two/four-wheel drive switching device for a vehicle which permits the application of a rear brake and engine brake to both front and rear wheels even in a two-wheel drive mode while minimize a switching noise.

The two/four-wheel drive switching device for a vehicle according to the present invention includes a switching unit, the switching unit being provided in one of the power transfer mechanisms disposed respectively between an engine and the front wheels and between the engine and rear wheels to permit and inhibit the transfer of power in the power transfer mechanism in which the switching unit is provided. The switching unit includes a drive shaft connected to a drive side, a driven shaft fitted on the drive shaft through an annular clearance, an odd number of engaging/disengaging members disposed between the drive shaft and the driven shaft for engagement with and disengagement from opposed surfaces of both shafts to connect and disconnect the shafts. A switching mechanism is provided for locating the engaging/disengaging members selectively in a position in which the drive shaft and the driven shaft are connected with each other and a position in which both shafts are disconnected from each other. An elastic member urges the engaging/disengaging members in a direction to connect the drive shaft and the driven shaft with each other, wherein with rotation of the drive shaft in a two-wheel drive mode, the engaging/disengaging members are moved in a direction to disconnect the drive shaft and the driven shaft from each other.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a sectional view showing an embodiment of the present invention;

FIGS. 2(a) and 2(d) are longitudinal sectional views of a principal portion according to the invention;

FIGS. 3(a) to 3(f) are enlarged sectional views for explaining the operation of a two/four-wheel drive switching device according to the embodiment;

FIG. 4 is a side view showing an example of a vehicle equipped with the two/four-wheel drive switching device;

FIG. 5 is a plan view for explaining a body construction of the vehicle shown in FIG. 4; and

FIG. 6 is a sectional view of a principal portion, showing a structural example of a conventional two/four-wheel drive switching device.

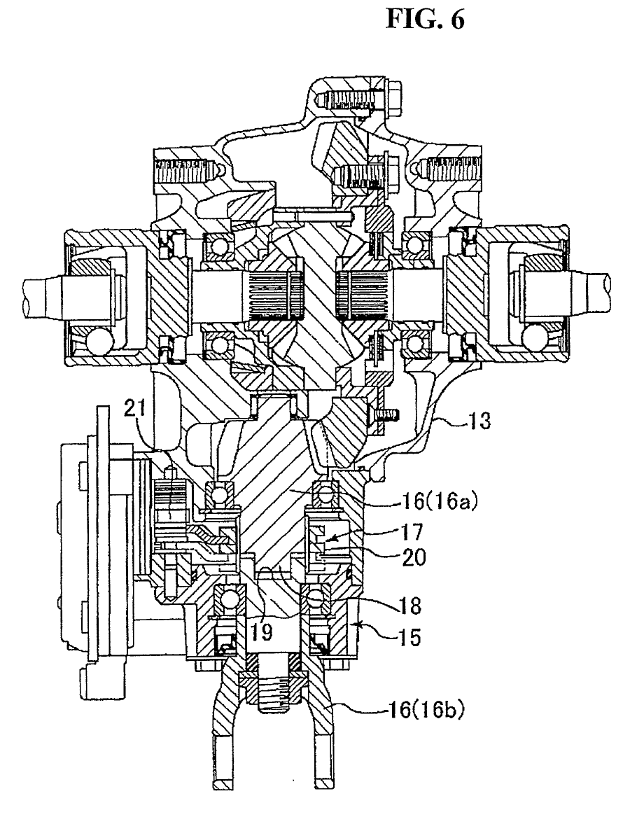

### DETAILED DESCRIPTION OF THE PREFERRED EMBODIMENTS

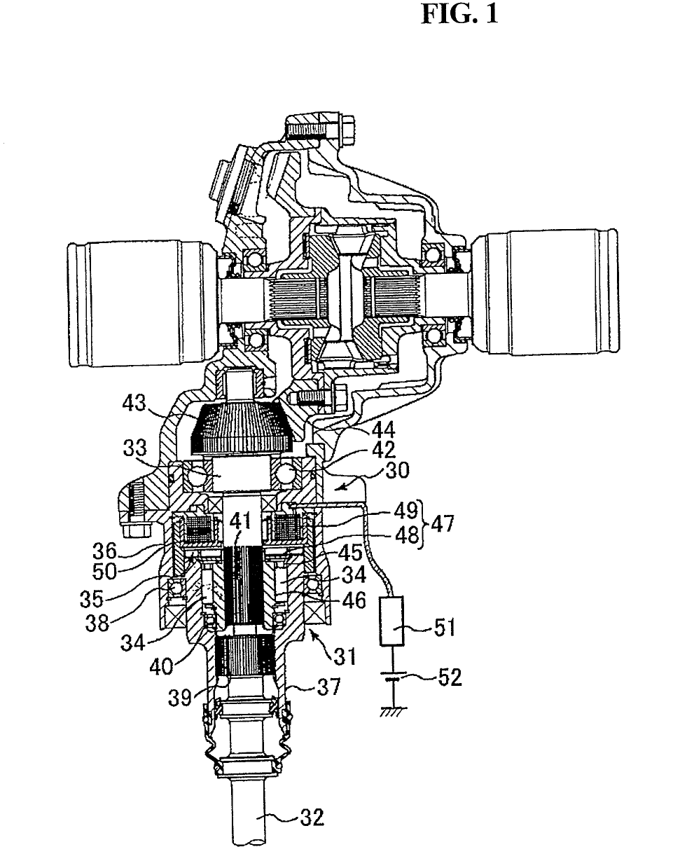

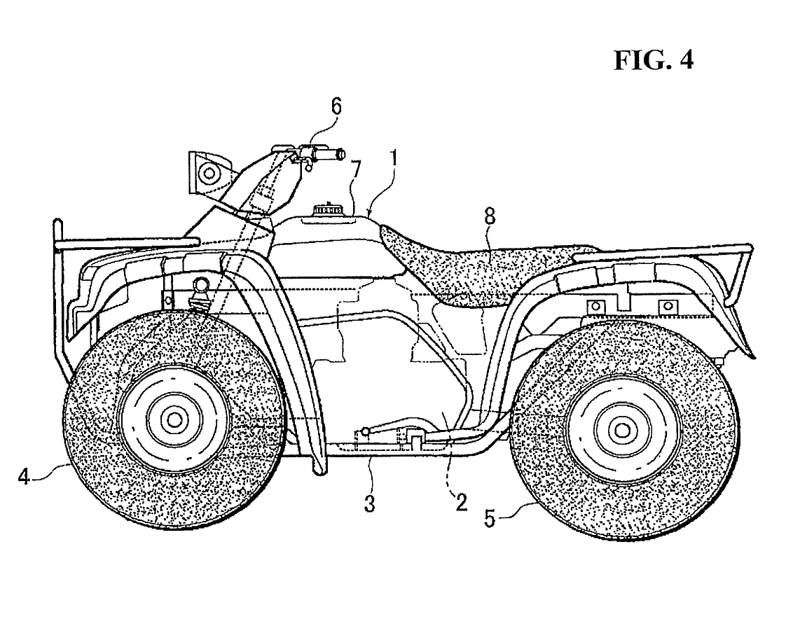

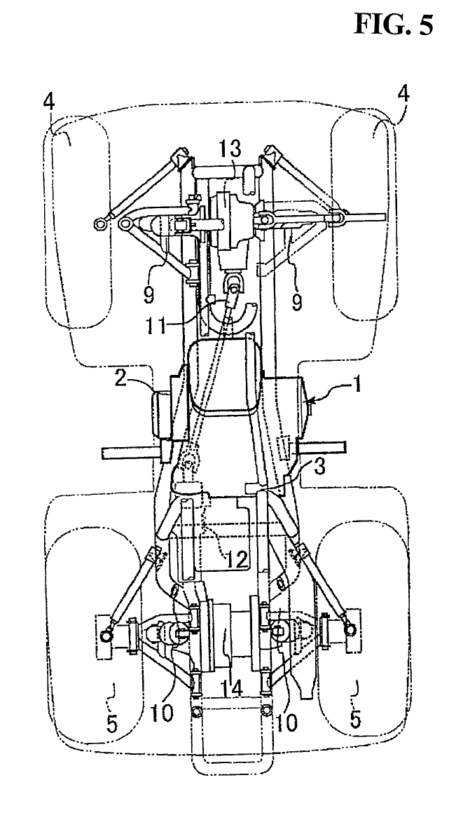

An embodiment of the present invention will be described below with reference to FIGS. 1 to 3. In the following description, principal components of a vehicle that are common to FIGS. 4 and 5 so will be identified by using the same reference numerals as in FIGS. 4 and 5 to simplify the related explanations.

A two/four-wheel drive switching device (hereinafter referred to simply as drive switching device) according to this embodiment, which is indicated at 30 in FIG. 1, is disposed in a power transfer mechanism installed between front wheels 4 and an engine 2. The two/four-wheel drive switching device 30 includes a switching unit 31 which permits and inhibits the transfer of power in the aforesaid power transfer mechanism. The switching unit 31 roughly includes a drive shaft 32 connected to a drive side, a driven shaft 33 fitted on the drive shaft 32 through an annular clearance, plural engaging/disengaging members 34 disposed in the clearance between the drive shaft 32 and the driven shaft 33 and adapted to be engaged with and disengaged from opposed surfaces of both shafts to connect and disconnect both shafts with and from each other. A switching mechanism 35 is provided for locating the engaging/disengaging members selectively in a position in which the drive shaft 32 and the driven shaft 33 are connected together and a position in which both shafts are disconnected from each other. A casing 36 encloses the components.

To be more specific, in this embodiment, a cylindrical outer ring 37 projects to the engine side and is rotatably mounted within the casing 36 through a bearing 38.

An inner peripheral surface of an engine-side end portion of the outer ring 37 is splined at 39 and the drive shaft 32 is inserted into the outer ring 37 so as to engage the spline 39, whereby the drive shaft 32 and the outer ring 37 are connected together.

Inside the outer ring 37 is disposed a cylindrical inner ring 40 through an annular spacing of a predetermined width formed between the inner ring and the outer ring.

An inner surface of the inner ring 40 is splined at 41 and the driven shaft 33 is inserted into the casing 36 and is connected to the inner ring 40 through the spline 41.

A longitudinally intermediate portion of the driven shaft 33 is supported rotatably by means of a bearing 42 attached to the casing 36.

A bevel gear 43 is integral with an end portion of the driven shaft 33 and is in mesh with a ring gear 44 in a final reduction unit 13 for the front wheels.

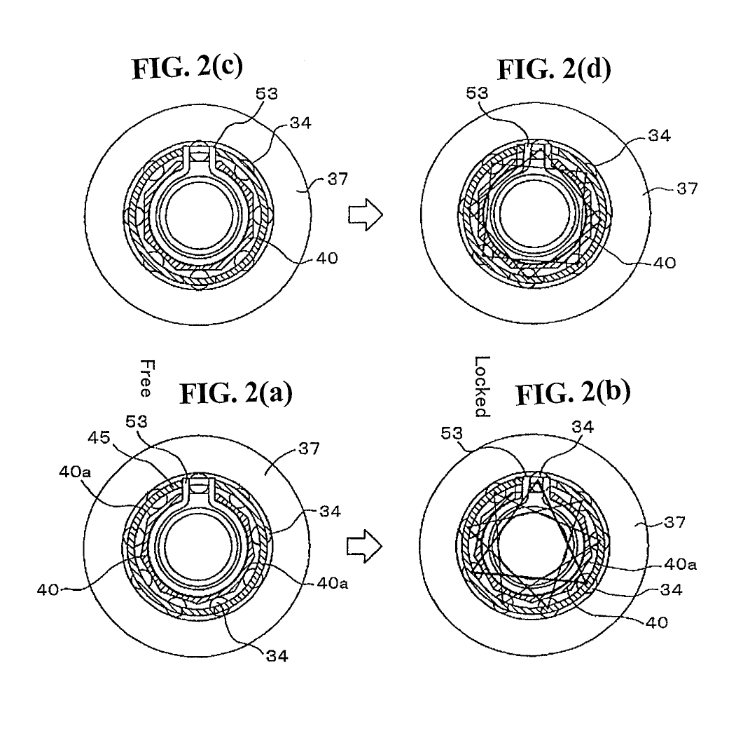

As shown in FIG. 1 and FIGS. 2(a) and (b), the engaging/disengaging members 34 includes a plurality of rollers arranged in parallel with the axis of the outer ring 37.

The switching mechanism 35, which rotatably holds the engaging/disengaging members 34, is made up of a retainer 45 fitted in the outer ring 37 and is relatively rotatably (relatively movably about the axis). A cam 46 is formed on the surface of the inner ring 40 and causes the engaging/disengaging members 34 to radially move with a relative movement with the retainer 45.

The engaging/disengaging members 34 are provided in an odd number, nine in this embodiment. The cam surfaces 40a are formed on the inner ring 40 and are also provided as nine cam surfaces.

Between the retainer 45 and the inner ring 40 is disposed an elastic member 53 which urges the retainer 45 in a direction opposite to a rotational direction of the drive shaft 32 in a forward travel of the vehicle 1, thereby urging the engaging/disengaging members 34 in a direction in which the outer ring 37 and the inner ring 40 are coupled together.

The elastic member 53 is formed in a generally C shape, ends of which are engaged in the rotational direction with the retainer 45 and the inner ring 40 in a compressed state.

An electromagnetic clutch 47 which fixes and disconnects the retainer 45 and the outer ring 37 and which constitutes the switching mechanism 35, is provided at an end portion of the outer ring 37 which end portion is positioned inside the casing 36.

The electromagnetic clutch 47 is made up of a clutch plate 48 interposed between the retainer 45 and the outer ring 37 and an electromagnetic coil 49 for engagement and release of the clutch plate 48.

The electromagnetic coil 49 energizes the clutch plate 48 into an engaged state, thereby fixing the retainer 45 and the outer ring 37 so as to inhibit a relative rotation between the two.

The electromagnetic coil 49 is formed in an annular shape and is received within a housing 50 which is also formed in an annular shape and constitutes an iron core. The housing 50 is fitted in the casing 36 so as to surround the driven shaft 33 and is thereby secured to the casing.

The outer ring 37, the inner ring 40, and the switching mechanism 35 are unitized into the casing 36.

As shown in FIG. 1, in a mounted state of the driven shaft 33, the casing 36 is bolted to a case of the final reduction unit for the front wheels and is thereby secured to the case.

A control unit 51 for ON-OFF control of the electromagnetic coil 49 and a power supply 52 for the supply of driving power to the electromagnetic coil 49 are connected to the electromagnetic coil.

In the drive switching device 30 according to this embodiment constructed as above, for canceling the transfer of driving power to the front wheels 4, the supply of electric current to the electromagnetic coil 49 is cut off to release the fixed state of the retainer 45 and the outer ring 37 fixed by the electromagnetic clutch 47.

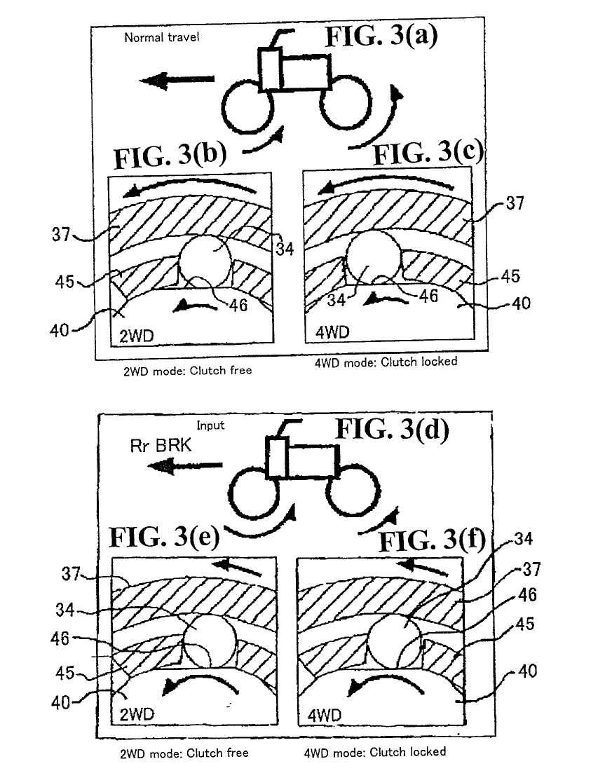

In this state, as shown in FIG. 3(b), the engaging/disengaging members 34 are urged to one top portion of the cam 46 and are brought into elastic abutment against the outer ring 37 and the inner ring 40 by means of the elastic member 53. In this case, since the rotating force of the outer ring 37 is large as indicated with the arrows in FIGS. 3(a) and (b), the engaging/disengaging members 34 are moved by the outer ring 37 in a direction of disconnection from the inner ring 40 against the urging force of the elastic member 53.

As a result, the outer ring 37 and the inner ring 40 are disconnected from each other, the transfer of rotation of the drive shaft 32 to the driven shaft 33 is blocked and hence the rotation of the front wheels is stopped.

If the brake is applied, for example, to the rear wheels 5 in such a two-wheel drive mode, the rotating force of the outer ring 37 decreases as indicated by the arrows in FIGS. 3(d) and (e), so that the engaging/disengaging members 34 urged by the elastic member 53 are moved toward one top portion of the cam surfaces 40a of the cam 46.

Consequently, the front and rear wheels 4, 5 are connected and brake is applied to both wheels. This is also the case with the application of engine brake.

For switching into the four-wheel drive mode, the electromagnetic coil 49 is energized to engage the electromagnetic clutch 47, thereby fixing the retainer 45 to the outer ring 37.

As a result, the engaging/disengaging members 34 held by the retainer 45 are moved together with the outer ring 37 to the other top portion of the cam 46 formed on the inner ring 40 and at the same time are brought into abutment against the inner surface of the outer ring 37, as shown in FIG. 3(c).

As a result, the outer ring 37 and the inner ring 40 are connected together through the engaging/disengaging members 34, so that the drive shaft 32 and the driven shaft 33 are coupled together and the rotation of the drive shaft 32 is transmitted to the driven shaft 33 to start rotation of the front wheels 4.

If the rear wheels 5 are braked in this four-wheel drive mode, the inner ring 40 is the first to rotate, so that one top portion of the cam 46 is formed on the inner ring 40 and is brought into abutment against the engaging/disengaging members 34, as shown in FIG. 3(f). Consequently, the four-wheel drive mode is retained and the brake is applied to both front and rear wheels 4, 5 in the same way as above.

When the inner ring 40 and the outer ring 37 are connected together by the engaging/disengaging members 34 in the manner described above, since the engaging/disengaging members 34 are provided in an odd number, nine in this embodiment, three engaging/disengaging members 34 come into abutment with both rings in the initial stage of the connection, as shown in FIG. 2(b), followed by successive abutment of the other engaging/disengaging members 34.

Therefore, the inner ring 40 and the outer ring 37 are contacted together at three points and are thus subjected to centering.

Consequently, the foregoing connection balance is improved to suppress the generation of noise and the pressure of contact of the engaging/disengaging members 34 with the inner and outer rings 40, 37 is reduced, thus permitting the reduction in size of the device.

In contrast therewith, if the engaging/disengaging members 34 are provided in an even number, as shown in FIGS. 2(c) and (d), the inner and outer rings 40, 37 are contacted together at two positions in the initial stage of the connection as in FIG. 2(d), followed by successive contact with the engaging/disengaging members 34. Thus, centering of both rings cannot be done immediately and hence the generation of noise may result.

In the drive switching device 30 of this embodiment thus constructed, when the brake is applied, the outer ring 37 and the inner ring 40 are connected together under the action of the elastic member 53 and the braking force of rear brake and engine brake can be applied to the front and rear wheels 4, 5.

The foregoing function can be attained by such a simple configuration as the elastic member 53 is interposed between the retainer 45 and the inner ring 40.

The shapes and sizes of the components referred to in the above embodiment are only one example and various modifications may be made according to design requirements, etc.

According to the present invention, as set forth above, when brake is applied, the braking force of rear brake and engine brake can be applied to both front and rear wheels no matter in which of two- and four-wheel drive modes the vehicle operation may be.

Besides, the above function can be attained by such a simple configuration as the elastic member is brought into engagement with the engaging/disengaging member.

Further, by providing an odd number of engaging/disengaging members, three abutment positions of the engaging/disengaging members are ensured in the initial stage of connection of both inner and outer rings, thereby effecting an efficient centering of both rings, whereby not only the generation of noise is suppressed, but also it is possible to reduce the contact pressure and attain the reduction in size of the device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A two/four-wheel drive switching device for a vehicle, comprising:
a switching unit, the switching unit being provided in one of power transfer mechanisms disposed respectively between an engine and front wheels and between the engine and rear wheels to permit and inhibit the transfer of power in the power transfer mechanism in which the switching unit is provided, the switching unit including:
a drive shaft connected to a drive side;
a driven shaft fitted on the drive shaft through an annular clearance;
an odd number of engaging/disengaging members disposed between the drive shaft and the driven shaft for engagement with and disengagement from opposed surfaces of both said shafts to connect and disconnect the shafts;
a switching mechanism for locating the engaging/disengaging members selectively in a position in which the drive shaft and the driven shaft are connected with each other and a position in which both said shafts are disconnected from each other; and
an elastic member which urges the engaging/disengaging members in a direction to connect the drive shaft and the driven shaft with each other,
wherein with rotation of the drive shaft in a two-wheel drive mode, the engaging/disengaging members are moved in a direction to disconnect the drive shaft and the driven shaft from each other.

2. The two/four-wheel drive switching device for a vehicle according to claim 1, wherein said switching member includes a retainer fitted in an outer ring, said retainer being relatively rotatable and movable about the driven shaft and the drive shaft, a cam formed on a surface of an inner ring for selectively moving the engaging/disengaging members to radially move with a relative movement with the retainer.

3. The two/four-wheel drive switching device for a vehicle according to claim 2, wherein the cam formed on the surface of the inner ring includes nine cam surfaces.

4. The two/four-wheel drive switching device for a vehicle according to claim 2, wherein said elastic member is disposed between the retainer and the inner ring for urging the retainer in a direction opposite to a rotational direction of the drive shaft during a forward travel of the vehicle.

5. The two/four-wheel drive switching device for a vehicle according to claim 4, wherein the elastic member urges the engaging/disengaging members in a direction wherein the outer ring and the inner ring are coupled together.

6. The two/four-wheel drive switching device for a vehicle according to claim 2, wherein said elastic member is C shaped wherein ends of the elastic member are engaged in the rotational direction with the retainer and the inner ring in a compressed condition.

7. The two/four-wheel drive switching device for a vehicle according to claim 2, wherein said switching mechanism includes an electromagnetic clutch for fixing and disconnecting the retainer and the outer ring, said electromagnetic clutch being positioned at an end portion of said outer ring.

8. The two/four-wheel drive switching device for a vehicle according to claim 7, wherein said electromagnetic clutch includes a clutch plate interposed between the retainer and the outer ring and an electromagnetic coil for engagement and release of the clutch plate.

9. The two/four-wheel drive switching device for a vehicle according to claim 8, wherein in an energized state the electromagnetic clutch engages the clutch plate thereby fixing the retainer and the outer ring to inhibit relative rotation therebetween.

10. A two/four-wheel drive switching device for a vehicle, comprising:
a switching unit operatively mounted in one of power transfer mechanisms disposed respectively between an engine and front wheels and between the engine and rear wheels to permit and inhibit the transfer of power in the power transfer mechanism in which the switching unit is provided, the switching unit including:
a drive shaft connected to a drive side;
a driven shaft fitted on the drive shaft through an annular clearance;
engaging/disengaging means disposed between the drive shaft and the driven shaft for engagement with and disengagement from opposed surfaces of said drive shaft and said driven shaft to connect and disconnect the shafts;
switching means for locating the engaging/disengaging means selectively in a position in which the drive shaft and the driven shaft are connected with each other and a position in which both said shafts are disconnected from each other; and
biasing means for urging the engaging/disengaging means in a direction to connect the drive shaft and the driven shaft with each other,
wherein with rotation of the drive shaft in a two-wheel drive mode, the engaging/disengaging means are moved in a direction to disconnect the drive shaft and the driven shaft from each other.

11. The two/four-wheel drive switching device for a vehicle according to claim 10, wherein said switching means includes a retainer fitted in an outer ring, said retainer being relatively rotatable and movable about the driven shaft and the drive shaft, a cam formed on a surface of an inner ring for selectively moving the engaging/disengaging means to radially move with a relative movement with the retainer.

12. The two/four-wheel drive switching device for a vehicle according to claim 11, wherein the cam formed on the surface of the inner ring includes nine cam surfaces.

13. The two/four-wheel drive switching device for a vehicle according to claim 11, wherein said biasing means is disposed between the retainer and the inner ring for urging the retainer in a direction opposite to a rotational direction of the drive shaft during a forward travel of the vehicle.

14. The two/four-wheel drive switching device for a vehicle according to claim 13, wherein the biasing means urges the engaging/disengaging means in a direction wherein the outer ring and the inner ring are coupled together.

15. The two/four-wheel drive switching device for a vehicle according to claim 11, wherein said biasing means is C shaped wherein ends of the biasing means are engaged in the rotational direction with the retainer and the inner ring in a compressed condition.

16. The two/four-wheel drive switching device for a vehicle according to claim 11, wherein said switching means includes an electromagnetic clutch for fixing and disconnecting the retainer and the outer ring, said electromagnetic clutch being positioned at an end portion of said outer ring.

17. The two/four-wheel drive switching device for a vehicle according to claim 16, wherein said electromagnetic clutch includes a clutch plate interposed between the retainer and the outer ring and an electromagnetic coil for engagement and release of the clutch plate.

18. The two/four-wheel drive switching device for a vehicle according to claim 17, wherein in an energized state the electromagnetic clutch engages the clutch plate thereby fixing the retainer and the outer ring to inhibit relative rotation therebetween.
